(19) United States
(12) Patent Application Publication
(10) Pub. No.: US 2023/0353930 A1
(43) Pub. Date: Nov. 2, 2023

(54) Transmission Line Speakers for Artificial-Reality Headsets

(71) Applicant: META PLATFORMS TECHNOLOGIES, LLC, Menlo Park, CA (US)

(72) Inventor: Simon Porter, San Jose, CA (US)

(21) Appl. No.: 16/536,186

(22) Filed: Aug. 8, 2019

Related U.S. Application Data
(60) Provisional application No. 62/817,992, filed on Mar. 13, 2019.

(51) Int. Cl. H04R 1/10; H04R 5/033; G02B 27/01

(52) U.S. Cl. CPC H04R 1/1091; H04R 5/033; G02B 27/0176

(57) ABSTRACT

A head-mounted display is provided. The head-mounted display includes (A) a body and (B) one or more strap arms securing the body to a user's head. Each strap arm includes a housing defining: (i) a chamber, (ii) a first audio passage to transmit sound from the chamber to a first audio outlet that outputs sound, and (iii) a second audio passage to transmit sound from the chamber to a second audio outlet that outputs sound. Each strap arm also includes a speaker, positioned in the chamber, configured to emit sound into the first and second audio passages, wherein (i) a front side (e.g., a forward-facing surface) of the speaker faces the first audio passage and a back side (e.g., a rearward-facing surface) of the speaker faces the second audio passage, and (ii) the second audio passage is longer than the first audio passage.

### RELATED APPLICATION

This application claims priority to U.S. Provisional Patent Application No. 62/817,992, filed Mar. 13, 2019, entitled “Transmission Line Speakers for Artificial-Reality Headsets,” which is incorporated by reference herein in its entirety.

### TECHNICAL FIELD

The present disclosure generally relates to the field of head-mounted displays, and more specifically to speaker systems included in head-mounted displays.

### BACKGROUND

Head-mounted displays (HMDs) have wide applications in various fields, including engineering design, medical surgery practice, military simulated practice, and video gaming. For example, a user wears an HMD while playing video games so that the user can have a more interactive experience in a virtual environment. As opposed to other types of display devices, an HMD is worn directly over a user's head. The HMD may directly interface with a user's face while exerting pressure onto the user's head due to its weight. Hence, a strap system is used in the HMD to secure the HMD to the user's head in a comfortable manner.

Audio systems for HMDs are subject to constraints often not encountered in other devices. Common audio systems, such as earbuds or earphones, impose inconveniences onto users, such as the physical lines needed to transmit signals to the earbuds or earphones. Moreover, when the HMDs are used by multiple users, the sharing of earbuds or earphones between users can be undesirable to some users.

### SUMMARY

Accordingly, there is a need for audio devices and systems that can alleviate the drawbacks above. Embodiments relate to a head-mounted display that includes a transmission line speaker (also called a sound-producing device). The head-mounted display includes a body and one or more strap arms securing the body to a user's head. Each strap arm includes a housing defining: (i) a chamber, (ii) a first audio passage to transmit sound from the chamber to a first audio outlet that outputs sound, and (iii) a second audio passage to transmit sound from the chamber to a second audio outlet that outputs sound. Each strap arm also includes a speaker, positioned in the chamber, configured to emit sound into the first and second audio passages, where: (a) a front side of the speaker faces the first audio passage and a back side of the speaker faces the second audio passage, and (b) the second audio passage is longer than the first audio passage.

In some embodiments, sound output by the second audio outlet combines constructively with sound output by the first audio outlet (e.g., at a predetermined location, such as a user's ear canal, and/or at a predetermined frequency), and the combined sound has a sound-pressure level that is greater than a sound pressure level output by the speaker.

(A1) Embodiments herein also relate to a sound-producing device. The sound producing device includes a housing defining (i) a chamber, (ii) a first audio passage to transmit sound from the chamber to a first audio outlet that outputs sound, and (iii) a second audio passage, distinct from the first audio passage, to transmit sound from the chamber to a second audio outlet that outputs sound. The sound producing device also includes a speaker, positioned in the chamber, configured to emit sound into the first and second audio passages, wherein: (a) a front side of the speaker faces the first audio passage and a back side of the speaker faces the second audio passage, and (b) the second audio passage is longer than the first audio passage.

(A2) In some embodiments of A1, the speaker has a first cross-sectional area, and the second audio passage has a second cross-sectional area that is less than the first cross-sectional area.

(A3) In some embodiments of A2, the second cross-sectional area is less than half of the first cross-sectional area.

(A4) In some embodiments of A2-A3, the second cross-sectional area is approximately one-tenth of the first cross-sectional area.

(A5) In some embodiments of A1-A4, the housing includes: (i) a head portion, defining the chamber, sized to receive the speaker, and (ii) a body portion defining the first audio passage and the second audio passage.

(A6) In some embodiments of A5, the first and second audio passages are adjacent to each other in the body portion, and the first and second audio passages both extend away from the head portion along a length of the body portion.

(A7) In some embodiments of A5-A6, the head portion further includes a lid, and the lid seals the chamber to create a back volume between the back side of the speaker and an interior of the head portion.

(A8) In some embodiments of A7, the lid is detachably coupled to the head portion.

(A9) In some embodiments of A5-A8, the head portion includes a surface and sidewalls extending from the surface. The surface and sidewalls collectively define the chamber.

(A10) In some embodiments of A9, the surface defines one or more first audio inlets joining the chamber and the first audio passage. Furthermore, the sidewalls define one or more second audio inlets joining the chamber and the second audio passage.

(A11) In some embodiments of A1-A10, the second audio passage follows a serpentine path.

(A12) In some embodiments of A1-A11, acoustic waves that pass through the second audio passage have a phase offset relative to acoustic waves that pass through the first audio passage. In addition, the phase offset corresponds to a length of the second audio passage.

(A13) In some embodiments of A12, acoustic waves output by the second audio outlet, due to the phase offset, constructively interfere with other acoustic waves output by the first audio outlet at a target location.

(A14) In some embodiments of A1-A13, sound output by the first audio passage is directed in a predetermined direction according to a cross-sectional shape of the first audio passage and an arrangement of the first audio outlet.

(A15) In some embodiments of A14, the first audio outlet is composed of multiple openings defined along a length of the first audio passage.

(A16) In some embodiments of A1-A15, a length of the first audio passage determines a minimum frequency of sound waves output by the first audio outlet.

(A17) In some embodiments of A1-A16, the housing has opposing first and second end portions and the speaker is positioned toward the first end portion of the housing. Moreover, the first and second audio outlets are defined toward the second end portion of the housing.

(A18) In some embodiments of A1-A17, a non-zero distance separates the front side of the speaker from the first audio outlet.

(A19) In some embodiments of A1-A18, the first and second audio passages are made from tubing.

(A20) In one other aspect, a head-mounted display device is provided, and the head-mounted display device includes the structural characteristics for a sound-producing device described above in any of A1-A19.

### BRIEF DESCRIPTION OF DRAWINGS

For a better understanding of the various described embodiments, reference should be made to the Detailed Description section below, in conjunction with the following drawings in which like reference numerals refer to corresponding parts throughout the figures and specification.

FIG. 1 is a block diagram of an artificial-reality system in which an artificial-reality console operates in accordance with some embodiments.

FIG. 2A illustrates an embodiment of a virtual-reality headset.

FIG. 2B illustrates an embodiment of a virtual-reality headset outputting sound from strap arms in accordance with some embodiments.

FIG. 3 illustrates a diagram of a common sealed speaker in operation.

FIG. 4 illustrates a diagram of a transmission line speaker in operation.

FIGS. 5A and 5B illustrate different views of a strap arm with a transmission line speaker in accordance with some embodiments.

FIG. 5C illustrates a cross-sectional view of the strap arm of FIGS. 5A and 5B in accordance with some embodiments.

FIG. 5D illustrates a cross-sectional view (taken along line L1-L2 in FIG. 5C) of the strap arm of FIGS. 5A and 5B in accordance with some embodiments.

FIG. 6 illustrates an embodiment of a sound outlet of the transmission line speaker in accordance with some embodiments.

FIG. 7A illustrates another embodiment of a sound outlet of the transmission line speaker in accordance with some embodiments.

FIGS. 7B-7F illustrate sound propagating from the transmission line speaker shown in FIG. 7A in accordance with some embodiments.

FIG. 8 illustrates an embodiment of an artificial reality device.

FIG. 9 illustrates an embodiment of an augmented reality headset and a corresponding neckband.

FIG. 10 illustrates an embodiment of a virtual reality headset.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first audio outlet could be termed a second audio outlet, and, similarly, a second audio outlet could be termed a first audio outlet, without departing from the scope of the various described embodiments. The first audio outlet and the second audio outlet are both audio outlets, but they are not the same audio outlet, unless specified otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

Embodiments of the invention may include or be implemented in conjunction with an artificial-reality system. Artificial reality is a form of reality that has been adjusted in some manner before presentation to a user, which may be virtual reality (VR), augmented reality (AR), mixed reality (MR), hybrid reality, or some combination and/or derivatives thereof. Artificial-reality content may include completely generated content or generated content combined with captured (e.g., real-world) content. Artificial-reality content may include video, audio, haptic feedback, or some combination thereof, and any of which may be presented in a single channel or in multiple channels (such as stereo video that produces a three-dimensional effect to the viewer). In some embodiments, artificial reality is associated with applications, products, accessories, services, or some combination thereof, which are used to create content in an artificial reality and/or are otherwise used in (e.g., perform activities in) artificial reality. The artificial-reality system that provides the artificial-reality content may be implemented on various platforms, including a head-mounted display (HMD) connected to a host computer system, a standalone HMD, a mobile device or computing system, or any other hardware platform capable of providing artificial-reality content to one or more viewers. It is noted that while “virtual reality” is used below as the primary example in the discussion below, the virtual-reality systems and headsets could be replaced with augmented-reality systems or headsets, mixed-reality system or headsets, etc.

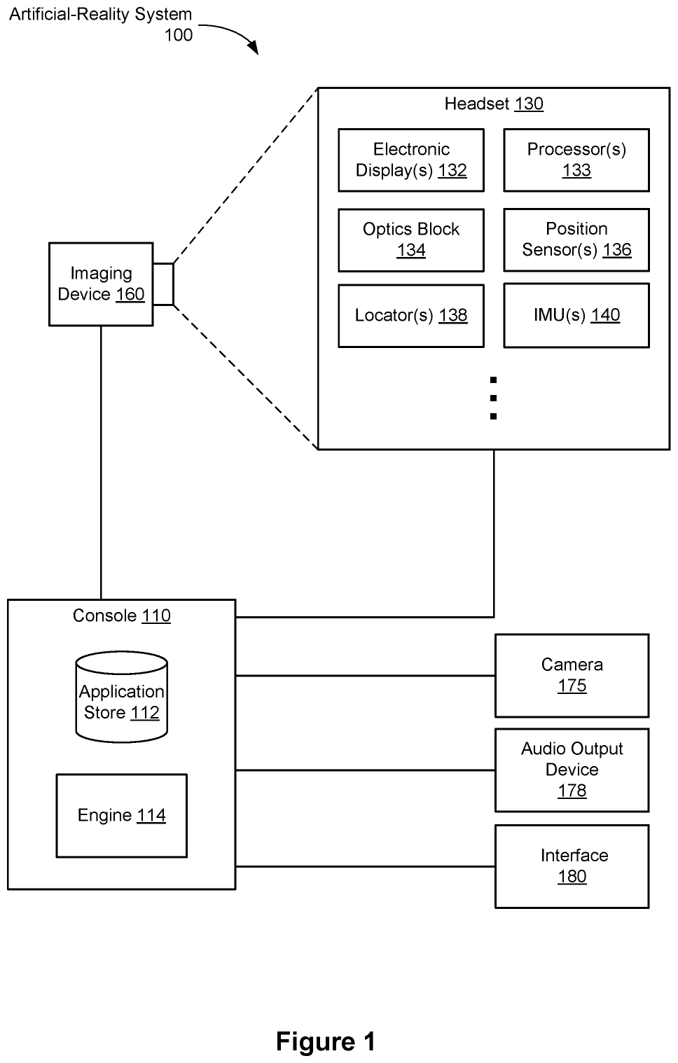

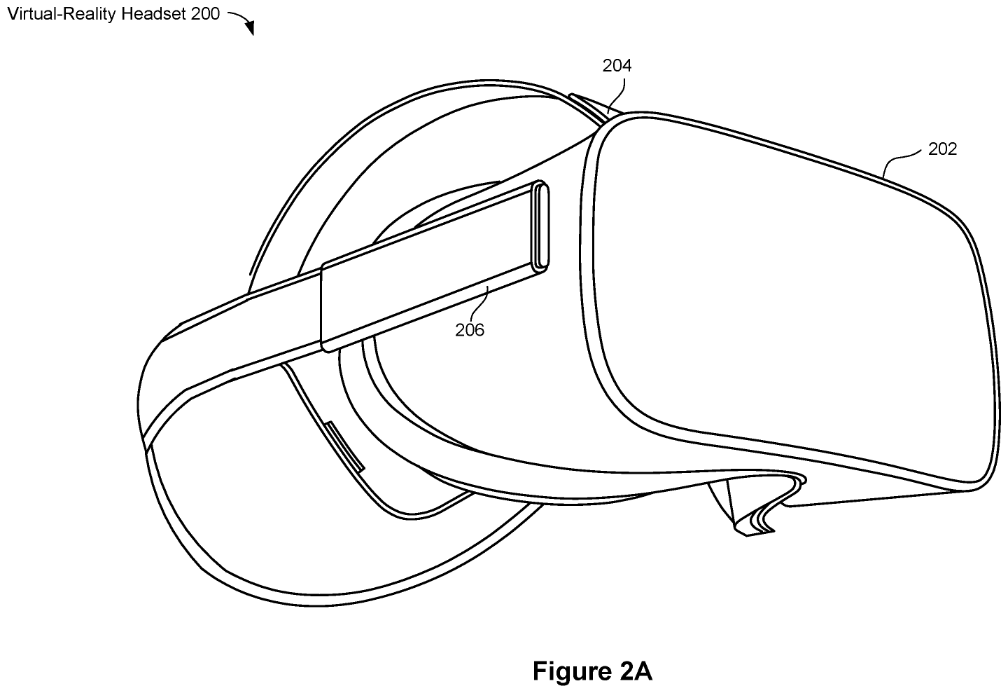

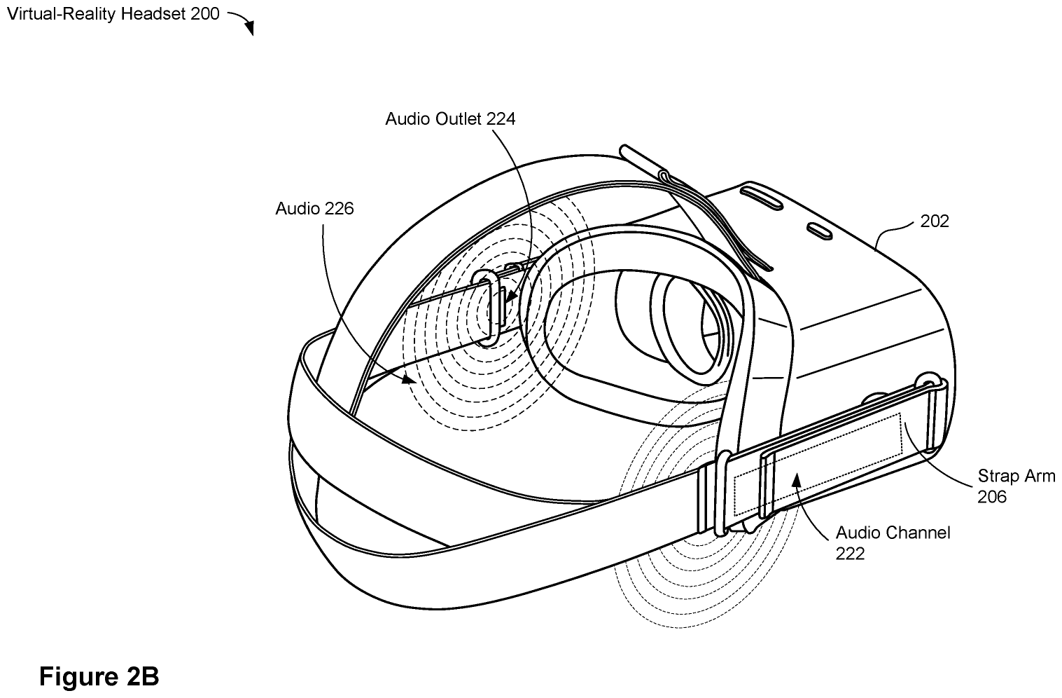

FIG. 1 is a block diagram of an artificial-reality system 100 in which a console 110 operates. The artificial-reality system 100 includes an artificial-reality headset 130, an imaging device 160, a camera 175, an audio output device 178, and an input interface 180, which are each coupled to the console 110. While FIG. 1 shows an example artificial-reality system 100 including one headset 130, one imaging device 160, one camera 175, one audio output device 178, and one input interface 180, in other embodiments any number of these components may be included in the system 100. FIGS. 2A and 8-10 show perspective views of example artificial-reality devices.

The artificial-reality headset 130 is a head-mounted display (HMD) that presents media to a user. Examples of media presented by the artificial-reality headset include one or more images, video, or some combination thereof. The artificial-reality headset 130 may comprise one or more rigid bodies, which may be rigidly or nonrigidly coupled to each other. A rigid coupling between rigid bodies causes the coupled rigid bodies to act as a single rigid entity. In contrast, a nonrigid coupling between rigid bodies allows the rigid bodies to move relative to each other.

The artificial-reality headset 130 includes one or more electronic displays 132, one or more processors 133, an optics block 134, one or more position sensors 136, one or more locators 138, and one or more inertial measurement units (IMUs) 140. The electronic displays 132 display images to the user in accordance with data received from the console 110.

The optics block 134 magnifies received light, corrects optical errors associated with the image light, and presents the corrected image light to a user of the artificial-reality headset 130. In various embodiments, the optics block 134 includes one or more optical elements. Example optical elements include: an aperture, a Fresnel lens, a convex lens, a concave lens, a filter, or any other suitable optical element that affects image light (or some combination thereof).

The locators 138 are objects located in specific positions on the artificial-reality headset 130 relative to one another and relative to a specific reference point on the artificial-reality headset 130. A locator 138 may be a light-emitting diode (LED), a corner cube reflector, a reflective marker, a type of light source that contrasts with an environment in which the artificial-reality headset 130 operates, or some combination thereof. In embodiments where the locators 138 are active (e.g., an LED or other type of light-emitting device), the locators 138 may emit light in the visible band (about 380 nm to 750 nm), the infrared (IR) band (about 750 nm to 1 mm), the ultraviolet band (about 10 nm to 380 nm), some other portion of the electromagnetic spectrum, or in some combination thereof.

The IMU 140 is an electronic device that generates first calibration data indicating an estimated position of the artificial-reality headset 130 relative to an initial position of the artificial-reality headset 130 based on measurement signals received from one or more of the one or more position sensors 136. A position sensor 136 generates one or more measurement signals in response to motion of the artificial-reality headset 130. Examples of position sensors 136 include: one or more accelerometers, one or more gyroscopes, one or more magnetometers, another suitable type of sensor that detects motion, a type of sensor used for error correction of the IMU 140, or some combination thereof. The position sensors 136 may be located external to the IMU 140, internal to the IMU 140, or some combination thereof.

The imaging device 160 generates second calibration data in accordance with calibration parameters received from the console 110. The second calibration data includes one or more images showing observed positions of the locators 138 that are detectable by the imaging device 160. The imaging device 160 may include one or more cameras, one or more video cameras, any other device capable of capturing images that include one or more of the locators 138, or some combination thereof. Additionally, the imaging device 160 may include one or more filters (e.g., for increasing signal to noise ratio). The imaging device 160 is configured to detect light emitted or reflected from the locators 138 in a field of view of the imaging device 160. In embodiments where the locators 138 include passive elements (e.g., a retroreflector), the imaging device 160 may include a light source that illuminates some or all of the locators 138, which retro-reflect the light toward the light source in the imaging device 160. The second calibration data is communicated from the imaging device 160 to the console 110, and the imaging device 160 receives one or more calibration parameters from the console 110 to adjust one or more imaging parameters (e.g., focal length, focus, frame rate, ISO, sensor temperature, shutter speed, or aperture).

The input interface 180 is a device that allows a user to send action requests to the console 110. An action request is a request to perform a particular action. For example, an action request may be to start or end an application or to perform a particular action within the application.

The camera 175 captures one or more images of the user. The images may be two-dimensional or three-dimensional (3D). For example, the camera 175 may capture 3D images or scans of the user as the user rotates his or her body in front of the camera 175. Specifically, the camera 175 represents the user's body as a plurality of pixels in the images. In one particular embodiment referred to throughout the remainder of the specification, the camera 175 is a red-green-blue (RGB) camera, a depth camera, an infrared (IR) camera, a 3D scanner, or a combination of the like. In such an embodiment, the pixels of the image are captured through a plurality of depth and RGB signals corresponding to various locations of the user's body. It is appreciated, however, that in other embodiments the camera 175 alternatively and/or additionally includes other cameras that generate an image of the user's body. For example, the camera 175 may include laser-based depth-sensing cameras. The camera 175 provides the images to an image-processing module of the console 110.

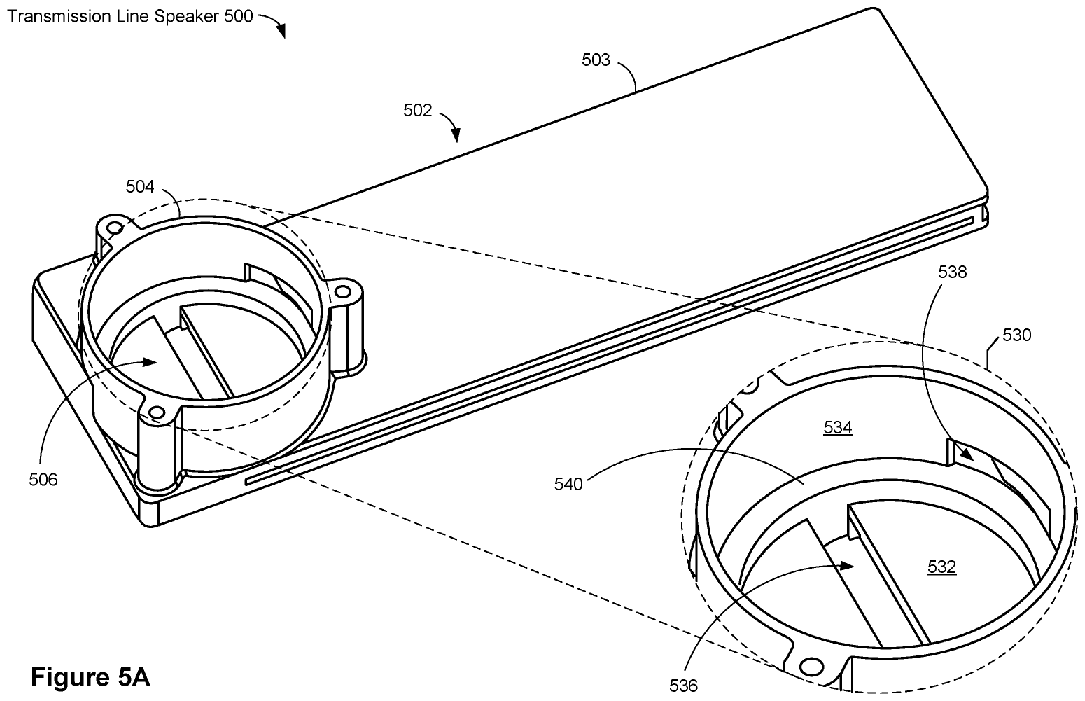

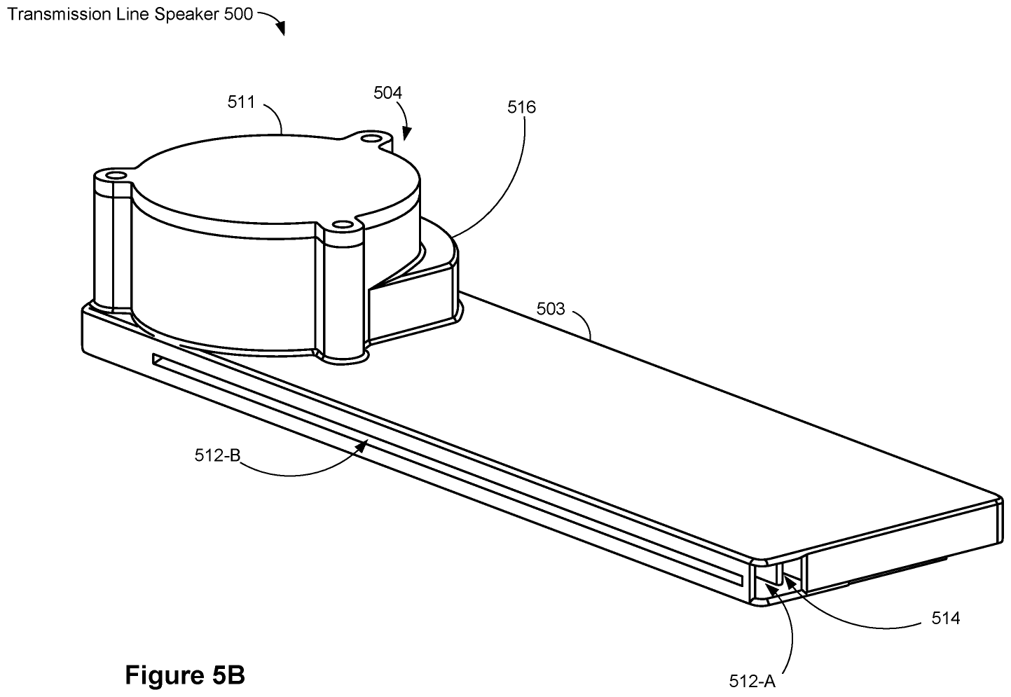

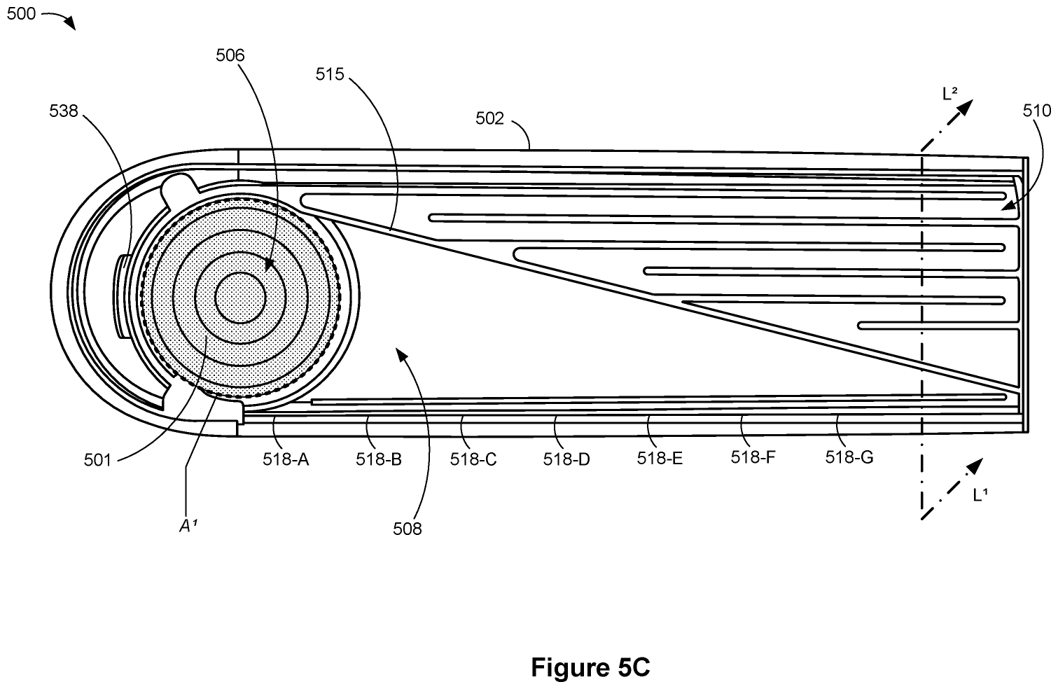

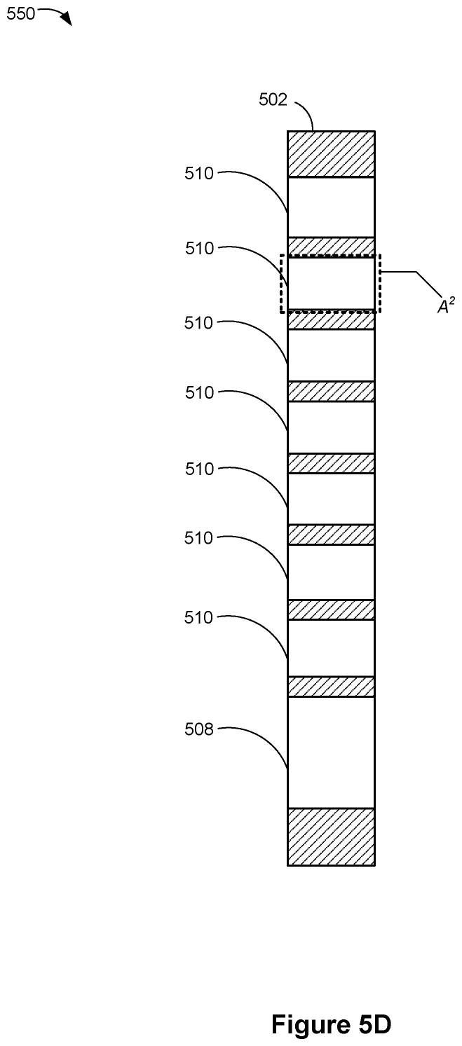

The audio output device 178 is a hardware device used to generate sounds, such as music or speech, based on an input of electronic audio signals. Specifically, the audio output device 178 transforms digital or analog audio signals into sounds that are output to users of the artificial-reality system 100. The audio output device 178 may be attached to the headset 130, or may be located separate from the headset 130. In some embodiments, the audio output device 178 is a headphone or earphone that includes left and right output channels for each ear, and is attached to the headset 130. However, in other embodiments, the audio output device 178 alternatively and/or additionally includes other audio output devices that are separate from the headset 130 but can be connected to the headset 130 to receive audio signals. As discussed below in connection to FIGS. 2B and 5A-5C, the audio output device 178 may include audio drivers (e.g., transducers, speakers, etc.) positioned within (e.g., in each strap arm of) an artificial-reality headset. An example of an audio driver positioned within a strap arm is shown in FIG. 5C (e.g., a driver 501 is housed by a housing 502 of a transmission line speaker 500).

The console 110 provides content to the artificial-reality headset 130 or the audio output device 178 for presentation to the user in accordance with information received from one or more of the imaging device 160 and the input interface 180. In the example shown in FIG. 1, the console 110 includes an application store 112 and an artificial-reality engine 114.

The application store 112 stores one or more applications for execution by the console 110. An application is a group of instructions, which, when executed by a processor, generates content for presentation to the user. Content generated by an application may be in response to inputs received from the user via movement of the artificial-reality headset 130 or the interface device 180. Examples of applications include gaming applications, conferencing applications, and video playback applications.

The artificial-reality engine 114 executes applications within the system 100 and receives position information, acceleration information, velocity information, predicted future positions, or some combination thereof, of the artificial-reality headset 130. Based on the received information, the artificial-reality engine 114 determines content to provide to the artificial-reality headset 130 for presentation to the user. For example, if the received information indicates that the user has looked to the left, the artificial-reality engine 114 generates content for the artificial-reality headset 130 that mirrors the user's movement in the virtual environment. Additionally, the artificial-reality engine 114 performs an action within an application executing on the console 110 in response to an action request received from the input interface 180 and provides feedback to the user that the action was performed. The provided feedback may be visual or audible feedback via the artificial-reality headset 130 (e.g., the audio output device 178) or haptic feedback via the input interface 180.

In some embodiments, the engine 114 generates (e.g., computes or calculates) a personalized head-related transfer function (HRTF) for a user and generates audio content to provide to users of the artificial-reality system 100 through the audio output device 178. The audio content generated by the artificial-reality engine 114 is a series of electronic audio signals that are transformed into sound when provided to the audio output device 178. The resulting sound generated from the audio signals is simulated such that the user perceives sounds to have originated from desired virtual locations in the virtual environment. Specifically, the signals for a given sound source at a desired virtual location relative to a user are transformed based on the personalized HRTF for the user and provided to the audio output device 178, such that the user can have a more immersive artificial-reality experience.

FIG. 2A is a perspective view of a virtual-reality headset 200. The virtual-reality headset 200 is an example of the artificial-reality headset 130 in FIG. 1. The virtual-reality headset 200 mostly or completely covers a user's field of view, and the headset 200 includes a front rigid body 202 and a strap system, whereby the strap system includes: (i) a band 204 shaped to fit around a user's head, and (ii) first and second strap arms 206 to further secure the headset 200 to the user's head. The first and second strap arms 206 may be coupled to the body 202 in variety of ways (e.g., fixably coupled, rotatably coupled, etc.). Additionally, the first and second strap arms 206 (and the band 204) may each include adjustment mechanisms to adjust a size (fit, snugness) of the strap system. The first and second strap arms 206 are discussed in further detail below in connection to FIG. 2B.

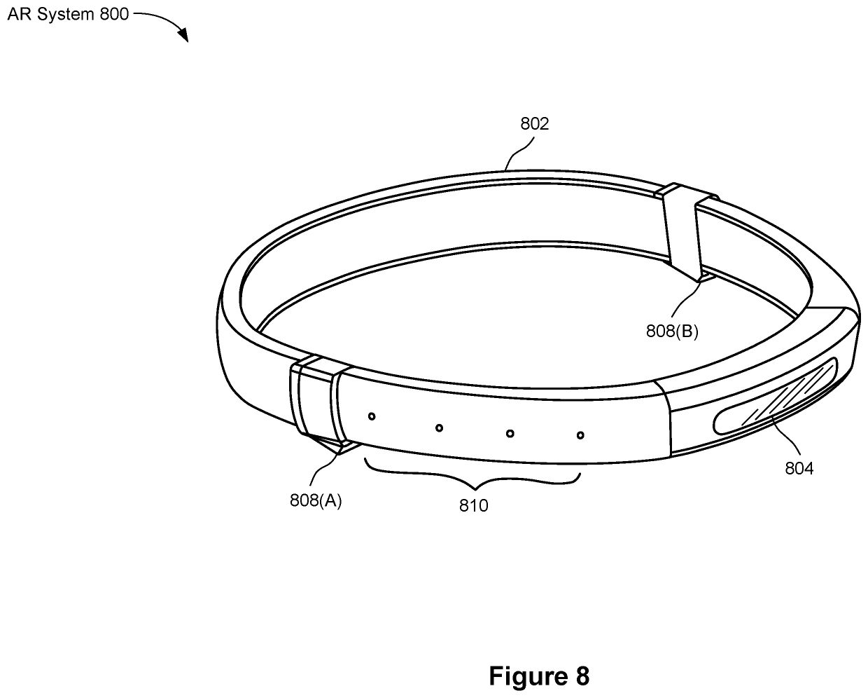

The virtual-reality headset 200 may also include output audio transducers (e.g., one or more instances of the audio output device 178) that output sound through the first and second strap arms 206 (discussed below in connection to FIG. 2B). Furthermore, while not shown in FIG. 2A, the body 202 may include one or more electronic elements, including one or more electronic displays 132, one or more IMUs 140, one or more tracking emitters or detectors (e.g., locators 138), and/or any other suitable device or system for creating an artificial-reality experience. Artificial-reality devices are discussed in further detail below with reference to FIGS. 8-10.

FIG. 2B is another perspective view of the virtual-reality headset 200. In some embodiments, the virtual-reality headset 200 includes audio channels 222 integrated with a component (e.g., the strap arms 206) of the virtual-reality headset 200. Specifically, the virtual-reality headset 200 includes a first audio channel 222 integrated with a first strap arm 206, which is positioned on the right side of the rigid body 202, and a second audio channel 222 integrated with the second strap arm 206, which is positioned on the left side of the rigid body 202. Each audio channel 222 includes one or more first openings adjacent to one of the electronic displays, and one or more second openings (e.g., an audio outlet 224) designed to be positioned adjacent to one of the user's ears (e.g., when the user is wearing the virtual-reality headset 200). Moreover, in some embodiments, each audio channel 222 includes first and second audio passages (e.g., each audio channel 222 is partitioned, and includes two distinct passage ways). Designs and arrangements of the first and second audio passages are discussed in further detail below with reference to FIGS. 5A-5C, 6, and 7A-7F.

As mentioned above, the virtual-reality headset 200 includes one or more first output audio transducers positioned within or near the one or more first openings of the first audio channel 222 and one or more second output audio transducers positioned within or near the one or more first openings of the second audio channel 222. Accordingly, when a respective audio transducer generates audio (e.g., acoustic waves, sound), the generated audio 226 enters the corresponding audio channel 222 via the one or more first openings of the respective audio channel and exits the respective audio channel 222 through the one or more second openings. In this way, audio generated by a respective output audio transducer is fed into the user's ear via the audio channel(s) 222, and thus, an efficient sound-delivery system is created.

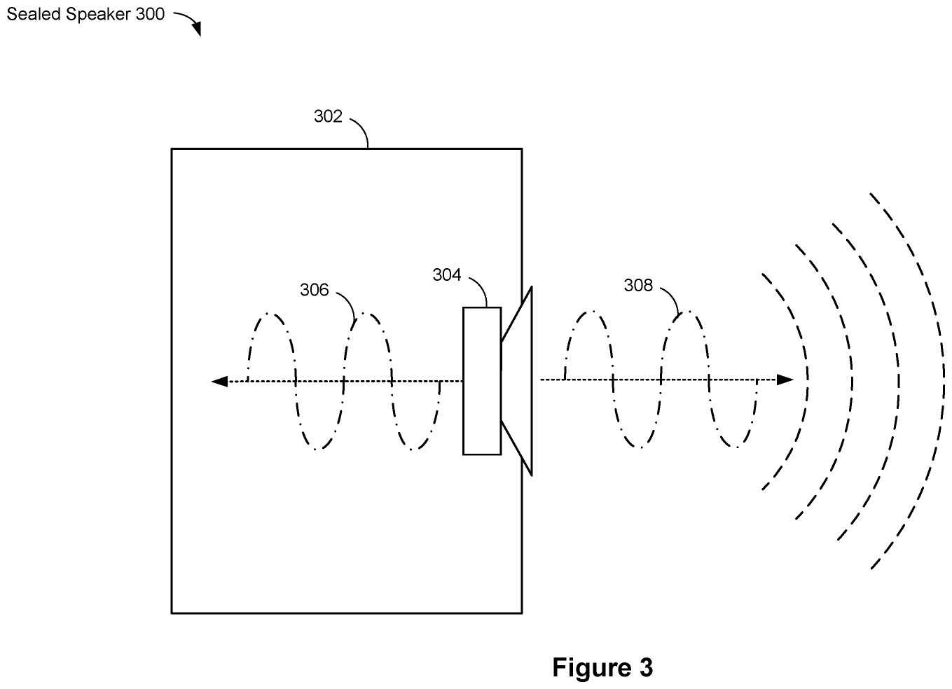

FIG. 3 is a diagram of a common sealed speaker 300 in operation. As shown, the sealed speaker 300 includes an enclosure 302 (e.g., a housing) and a driver 304 for creating acoustic waves (e.g., audio, sound). The driver 304 in the illustrated example is a common speaker driver that includes a rearward-facing surface and a forward-facing surface. Thus, when operating, the driver 304 outputs audio in opposing first and second directions (e.g., backward and forward). The enclosure 302 is used to prevent acoustic waves 306 generated by the rearward-facing surface of the driver 304 from interacting with acoustic waves 308 generated by the forward-facing surface of the driver 304. This is because the rearward- and forward-generated acoustic waves 306 and 308, respectively, are out of phase with each other, and thus, any interaction between the two in the listening space creates a distortion of the original signal, which is undesirable (e.g., undesired auditory effects are created). Accordingly, the enclosure 302 is provided to minimize interaction between the rearward- and forward-generated acoustic waves 306, 308.

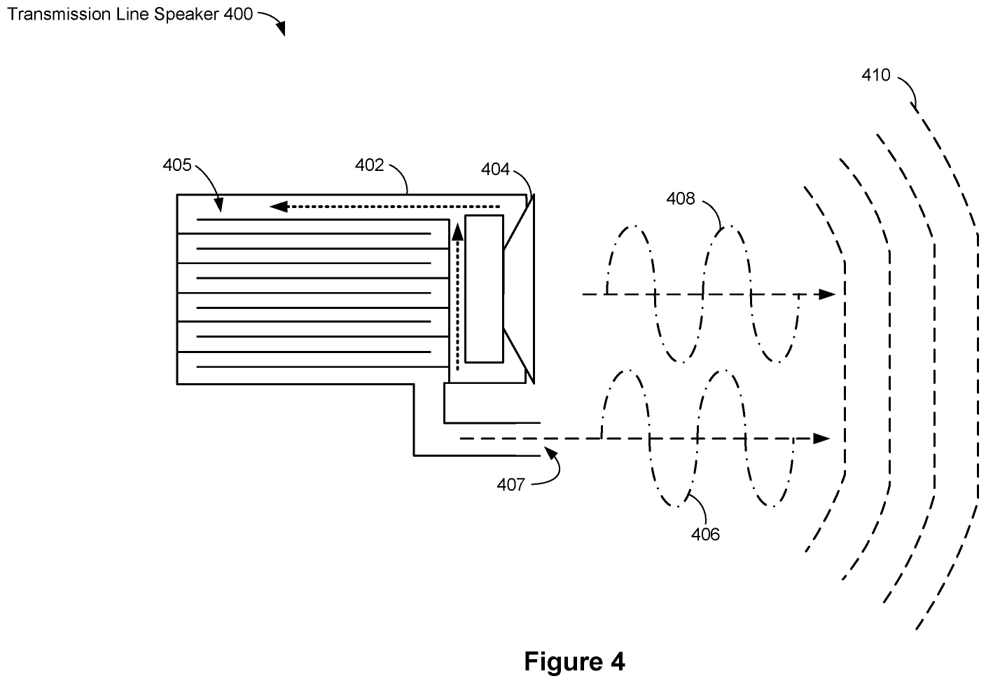

Common sealed speakers 300, however, suffer from many drawbacks. For example, panel resonance tends to be an issue with these types of speakers, which results from the rearward-generated acoustic waves 306 being trapped by the enclosure 302. Resonance can be reduced by modifying the shape of the enclosure 302 or by fabricating the enclosure 302 from different materials. However, these modifications can be costly and add unwanted steps to the manufacturing process. Furthermore, air in the enclosure 302 can act as a spring, which reduces the bass sensitivity of the sealed speaker 300. Moreover, additional voltage is required for the rearward-facing surface of the driver 304 to push against the air enclosed in the enclosure 302. In low-voltage applications (e.g., when the speaker is much smaller, such as an earbud), it is possible that sufficient voltage cannot be provided to the driver 304. As a result, the driver 304 functions improperly. In light of the above, different speaker designs have been developed over the years to alleviate the drawbacks associated with sealed speakers. One speaker design is a transmission line speaker, which is discussed below in connection with FIG. 4. It is noted that a design of the transmission line speaker 400 in FIG. 4 differs in critical ways from a conventional transmission line speaker (as also detailed below).

FIG. 4 is a diagram of a transmission line speaker 400 in operation. As shown, the transmission line speaker 400 includes an enclosure 402 (e.g., a housing) and a driver 404 for creating acoustic waves (e.g., audio, sound). Like the driver 304 in FIG. 3, the driver 404 is a common speaker driver that includes a rearward-facing surface and a forward-facing surface. Thus, when operating, the driver 404 outputs audio in opposing first and second directions (e.g., backward and forward). Unlike the enclosure 302, the enclosure 402 includes a meandering path 405 (i.e., a transmission line) that includes a plurality of turns (e.g., folds, switchbacks). Acoustic waves 406 generated by the rearward-facing surface of the driver 404 thus travel through the meandering path 405, as indicated by the dotted arrows in FIG. 4. The enclosure 402 further includes an audio outlet 407, and the acoustic waves 406 generated by the rearward-facing surface of the driver 404 exit the enclosure 402 via the audio outlet 407, as indicated by the dashed arrow exiting the outlet 407 in FIG. 4. In some embodiments, a dampening material is disposed in (e.g., a portion of or throughout) the transmission line 405.

The meandering path 405 serves several useful purposes. First, the meandering path 405 acts as a low-pass filter for the rearward-facing surface of the driver 404, whereby frequencies above a threshold frequency (e.g., 125 Hz) are absorbed. The meandering path 405 also acts to reduce the velocity of transmitted frequencies below the threshold frequency so that they will exit enclosure 402 without audible distortion from turbulent air.

Additionally, the meandering path 405 imparts a phase delay on the acoustic waves 406 that travel through the meandering path 405. Put another way, the acoustic waves 406 generated by the rearward-facing surface of the driver 404 are delayed relative to the acoustic waves 408 generated by the forward-facing surface of the driver 404. The length of the meandering path 405 is selected so that the phase delay imparted onto the acoustic waves 406 generated by the rearward-facing surface of the driver 404 corresponds to a phase of the acoustic waves 408 generated by the forward-facing surface of the driver 404. For example, the length of the meandering path 405 can range from approximately one-sixth to approximately one-half the wavelength of the fundamental resonant frequency of the driver 404. In doing so, the acoustic waves 406 generated by the rearward-facing surface of the driver 404 exit the enclosure 402 in phase with the acoustic waves 408 generated by the forward-facing surface of the driver 404 (e.g., the peaks and valleys of the acoustic waves 408 line up with the peaks and valleys of the acoustic waves 406, as shown in FIG. 4). Therefore, the acoustic waves 406 combine (e.g., constructively interfere) with the acoustic waves 408 at a target frequency to form final audio 410, thereby improving the efficiency (e.g., increasing the sound-pressure level) of the transmission line speaker 400 (e.g., relative to the efficiency of the sealed speaker 300). As an added benefit, the system's sensitivity below the fundamental resonant frequency is increased due to constructive interference.

The cross-sectional area of the meandering path 405 is less than the cross-sectional area of the driver 404. In some embodiments, the cross-sectional area of the meandering path 405 is one-eighth to one-half the cross-sectional area of the driver 404. In some embodiments, the cross-sectional area of the meandering path 405 is one-tenth (or less) of the cross-sectional area of the driver 404. Because the meandering path 405 can have a reduced cross-sectional area (relative to the cross-sectional area of the driver 404), the transmission line speaker 400 can be miniaturized, which allows the transmission line speaker 400 to be integrated with the strap arm 206. Even with this reduced cross-sectional area of the meandering path 405, the acoustic waves 406 generated by the rearward-facing surface of the driver 404 do not exceed a threshold velocity (e.g., acoustic waves that travel above the threshold velocity, such as 10 meters per second, may cause audible distortion). For comparison, in typical transmission line speakers, a cross-sectional area of the meandering path is equal to or greater than a cross-sectional area of the driver 404, which prevents typical transmission line speakers from being miniaturized.

The embodiments discussed below can relate to a strap system with strap arms (e.g., the strap arms 206 of FIGS. 2A and 2B) that incorporate audio passages and audio outlets for delivering sound generated by a virtual-reality headset to a user's ears. The strap arm performs the function of securing the head straps and transmitting sound generated from the virtual-reality headset to the user's ears. It is noted that the embodiments below (i) are not limited to virtual-reality headsets and (ii) can be used in other applications where audio outlets are positioned in close proximity to the user's/wearer's ears. For example, the embodiments below can be employed in helmets used in various sports and military applications. In other embodiments, audio passages and audio outlets for delivering sound to a user's ears may be a flexible pipe of small diameter routed around open areas within a device (i.e., the transmission line is not limited to strap arm; it can be a separate part, such as a flexible pipe). Additionally, the embodiments below are not restricted or otherwise limited to virtual-reality applications. For example, the embodiments below can also be implemented in headsets and systems involving augmented reality, mixed reality, hybrid reality, or some combination thereof.

FIGS. 5A and 5B are perspective views of a transmission line speaker 500 to be integrated with a virtual-reality headset in accordance with some embodiments. In some embodiments, the transmission line speaker 500 is integrated with a strap arm 206 of the virtual-reality headset 200 (FIGS. 2A and 2B). Alternatively, in some embodiments, the transmission line speaker 500 is the strap arm of the virtual-reality headset. While not shown, the transmission line speaker 500 may include fastening mechanisms (e.g., loops, buckles, clips, or hooks) that can be used to secure the transmission line speaker 500 to the virtual-reality headset. In some embodiments, each end of the transmission line speaker 500 includes a fastening mechanism sized to receive one or more straps of the virtual-reality headset. Additionally, the transmission line speaker 500 in FIGS. 5A-5C is designed to couple to a side of the virtual-reality headset's body (e.g., the right side of the rigid body 202 in FIG. 2A). In practice, the virtual-reality headset includes another instance of the transmission line speaker 500 designed to be coupled to the other side of the virtual-reality headset's body. The design of the other instance of the transmission line speaker 500 may mirror the design of the transmission line speaker 500 illustrated in FIGS. 5A-5C. For ease of discussion, the transmission line speaker 500 is sometimes referred to below as a “strap arm.” The transmission line speaker 500 is similar to (and in some instances is an example of) the transmission line speaker 400 in FIG. 4.

As shown in FIG. 5A, the transmission line speaker 500 includes an enclosure 502, which is also referred to herein as a “housing.” The enclosure 502 includes: (i) a head portion 504 that defines a chamber 506, and (ii) a body portion 503. The head portion 504 of the enclosure 502 is sized to receive a driver 501, as shown in FIG. 5C. The body portion 503 of the enclosure 502 defines a first audio passage 508 (shown in FIG. 5C) and a second audio passage 510 (shown in FIG. 5C). The second audio passage 510 is an example of the transmission line of FIG. 4 (e.g., the meandering path 405). The first audio passage 508 is acoustically coupled to the chamber 506 and is configured to transmit sound (e.g., acoustic waves) from the chamber 506 to a first audio outlet (outlet 512-A and/or outlet 512-B shown in FIG. 5B) that outputs the sound. The second audio passage 510 is also acoustically coupled to the chamber 506 and is configured to transmit sound from the chamber 506 to a second audio outlet 514 (shown in FIG. 5B) that outputs the sound. In some embodiments, the sound transmitted by the first audio passage 508 is generated by a forward-facing surface of the driver 501 (e.g., the acoustic waves 408 in FIG. 4), while the sound transmitted by the second audio passage 510 is generated by a rearward-facing surface of the driver 501 (e.g., the acoustic waves 406 in FIG. 4). Importantly, and as will be discussed in connection with FIG. 5C, sound output by the second audio outlet 514 combines constructively with sound output by the first audio outlet 512 at the tuned frequency, and the combined sound (e.g., the audio 410 in FIG. 4) has a sound-pressure level that is greater than a sound-pressure level of the sound generated by the forward-facing surface of the driver 501 alone (or the sound generated by the rearward-facing surface of the driver 501 alone).

As shown in the magnified view 530 of FIG. 5A, the head portion 504 includes a surface 532 and sidewalls 534 extending from the surface 532, whereby the surface 532 and sidewalls 534 collectively define the chamber 506. In addition, the surface 532 defines one or more first audio inlets 536 joining (e.g., acoustically coupling) the chamber 506 with the first audio passage 508. Moreover, the sidewalls 534 define one or more second audio inlets 538 joining (e.g., acoustically coupling) the chamber 506 with the second audio passage 510 (e.g., in some embodiments, another second audio inlet is defined opposite the audio inlet 538 shown in the magnified view 530). The magnified view 530 also illustrates a position of an annular ring 540 with respect to the one or more first audio inlets 536 and the one or more second audio inlets 538. The annular ring 540 (which may or may not be integrally formed with the enclosure 502) is used to prevent sound generated by the forward-facing surface of the driver 501 from entering the second audio passage 510, and vice versa (i.e., the annular ring 540 acoustically isolates the one or more second audio inlets 538 from the one or more first audio inlets 536). Furthermore, the annular ring 540 is sized to receive and house the driver 501 (i.e., the diameter of the annular ring 540 is approximately the same as the diameter of the driver 501).

As shown in FIG. 5B, in some embodiments, the head portion 504 of the enclosure 502 includes a lid 511. The lid 511, when coupled to the head portion 504, seals the chamber 506 to create a back volume between the rearward-facing surface of the driver 501 and an interior of the head portion 504. The back volume provides a cavity from which sound generated by the driver 501 can be reverberated toward the second audio passage 510. The back volume enhances the quality and/or volume of the sound provided to the user via the second audio passage 510. It is noted that the lid 511 can be detachably coupled to the head portion 504 (e.g., via mechanical fasteners). In this way, the lid 511 can be removed and the driver 501 therein can be accessed, cleaned, and/or otherwise adjusted, if needed (e.g., to replace a damaged speaker with a new speaker).

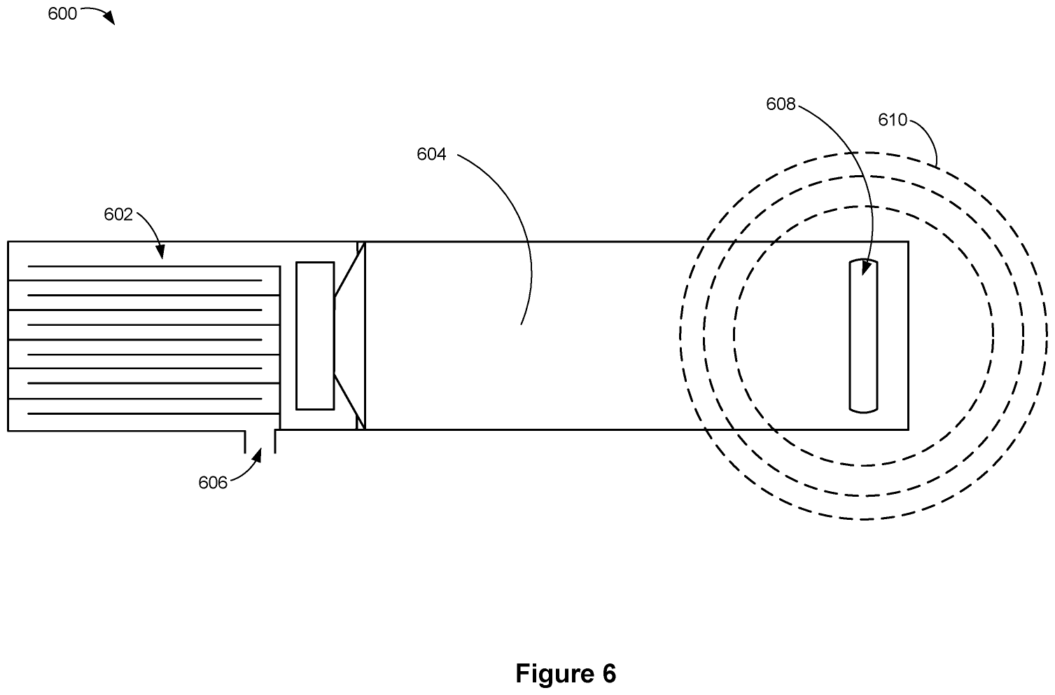

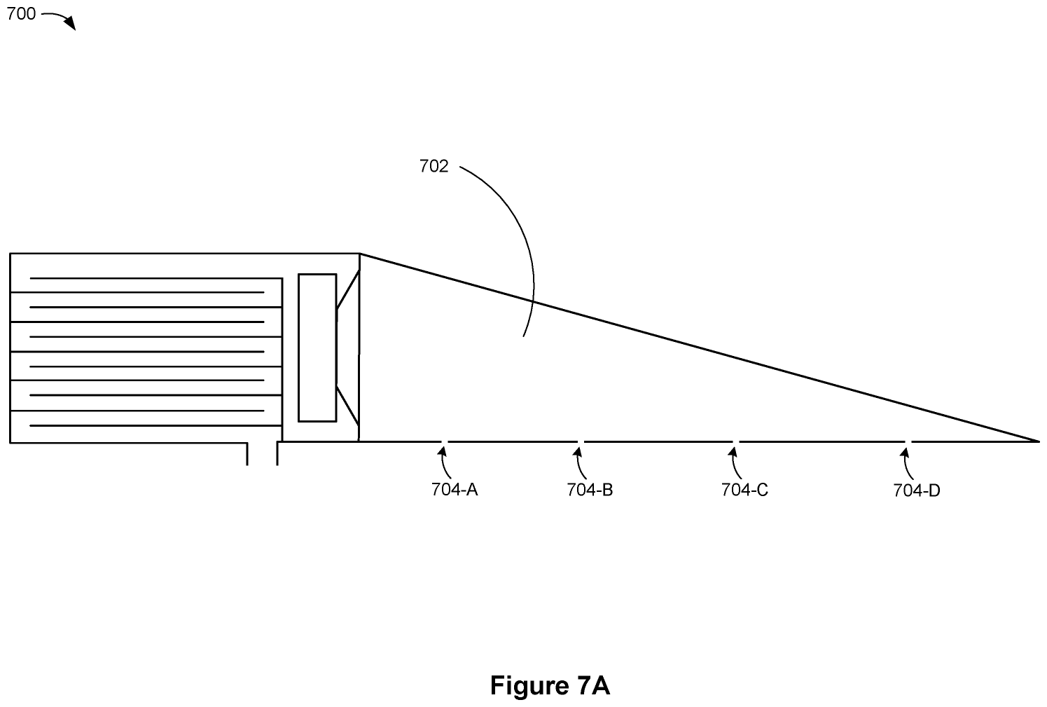

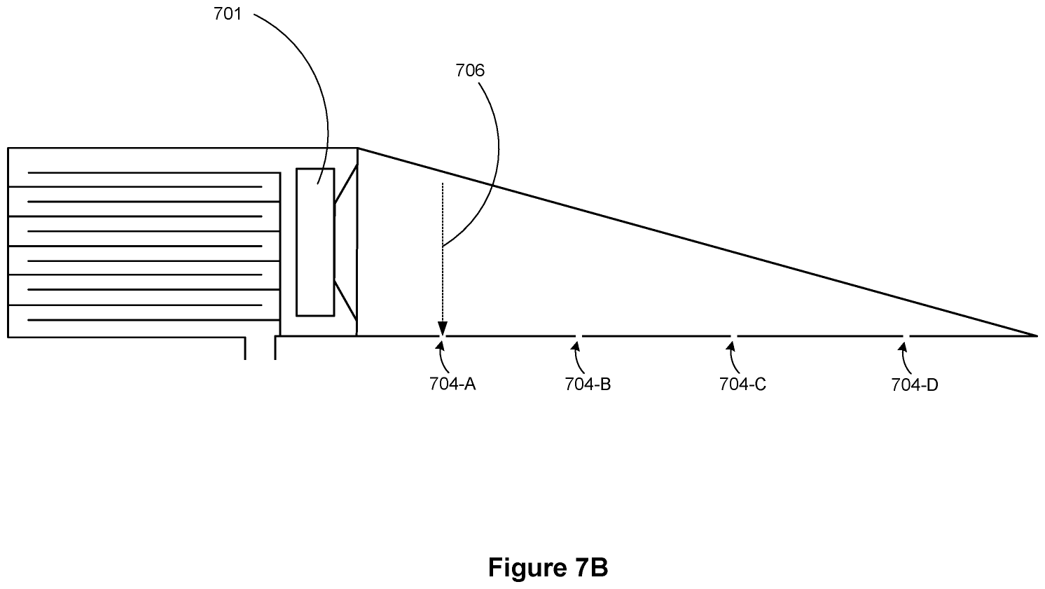

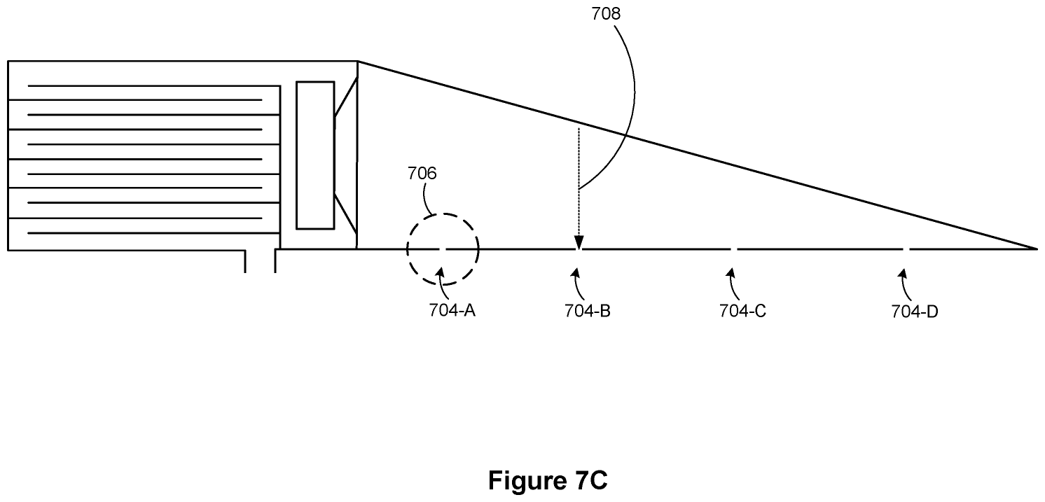

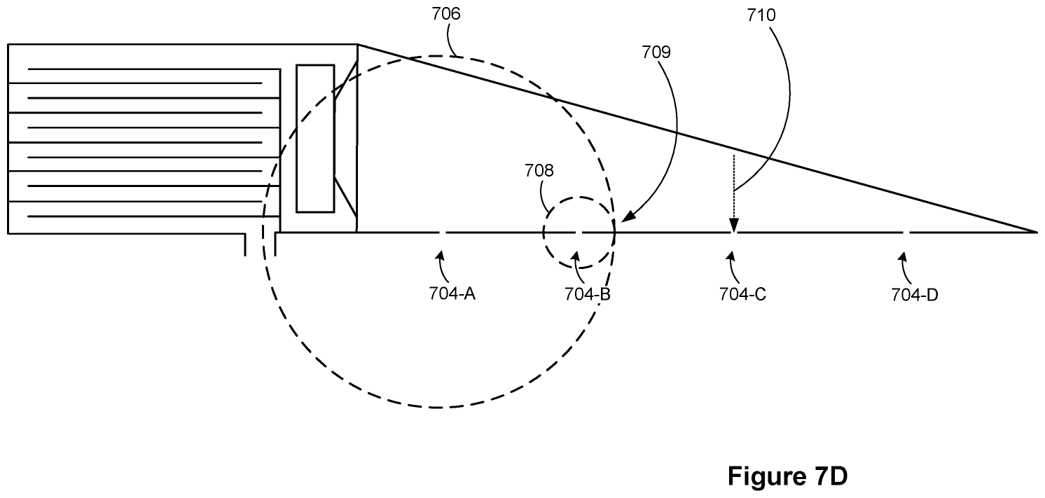

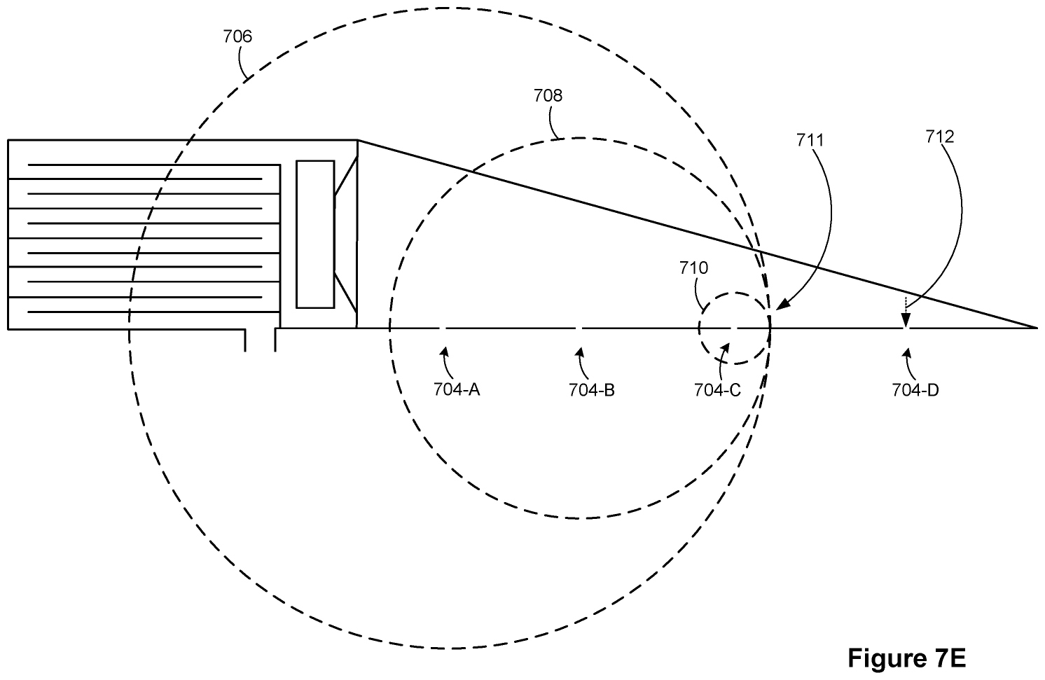

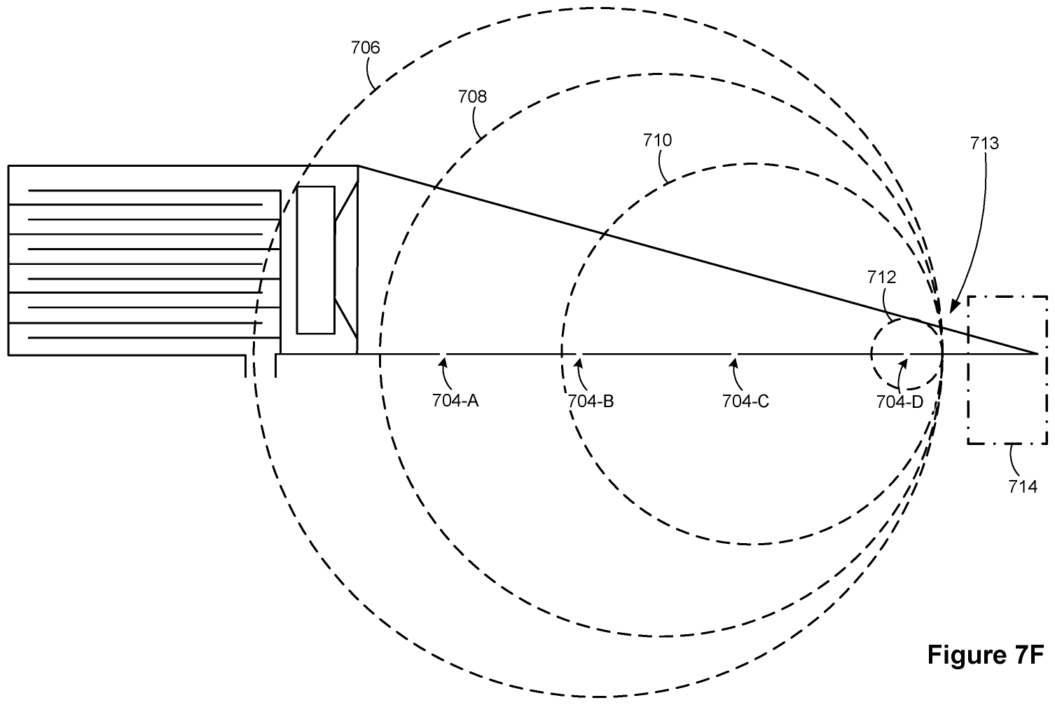

FIG. 5B also illustrates the first audio outlet 512, which outputs sound from the first audio passage 508. As shown, the first audio outlet 512 can have at least two different designs (e.g., outlet 512-A versus outlet 512-B). In some embodiments, the first audio outlet 512 is a single opening (port) 512-A defined toward a distal end of the first audio passage 508. In such embodiments, sound output by the first audio outlet 512-A is output in an omni-directional fashion, such as the radiated audio shown in FIG. 2B and FIG. 6. Alternatively or in addition, in some embodiments the first audio outlet 512-B includes a plurality of openings (e.g., perforations) 518-A through 518-G (FIG. 5C) defined along a length of the first audio passage 508. In such embodiments, sound output by the first audio outlet 512-B is directed in a predetermined direction, as is described in connection with FIGS. 7A-7F. In some embodiments, the predetermined direction is associated with one or more of a cross-sectional shape of the first audio passage 508, a length of the first audio passage 508, and an arrangement of the plurality openings 518-A through 518-G. In this way, the sound can be directed toward the user's ear, thereby reducing sound leakage into the surrounding environment. The openings 518-A through 518-G are discussed in further detail below with reference to FIGS. 7A-7F (e.g., with reference to the openings 704-A through 704-D).

FIG. 5B also illustrates the second audio outlet 514, which outputs sound from the second audio passage 510. In the illustrated embodiment, the second audio outlet 514 is positioned adjacent to the first audio outlet 512 (e.g., the first and second audio outlets are collocated). Alternatively, in some embodiments, the second audio outlet 514 feeds into the first audio passage 508, and sound transmitted by the second audio passage 510 exits the strap arm 500 via the first audio passage 512.

FIG. 5B also shows a side perspective view of the head portion 504 of the housing 502. As shown, the head portion 504 includes a stepped-out portion 516 that encloses the one or more second audio inlets 538. FIG. 5C shows that at least one second audio inlet 538 is formed on a right side of the head portion 504. While not shown, at least one other second audio inlet 538 may be formed on a left side of the head portion 504. It is noted that the stepped-out portion 516 may be formed elsewhere on the head portion 504, and, in some embodiments, the stepped-out portion 516 is not included.

FIG. 5C illustrates a cross-sectional view of the strap arm 500 of FIGS. 5A and 5B in accordance with some embodiments. As shown, the driver 501 is positioned in the chamber 506 defined by the enclosure 502. As discussed above, the enclosure 502 (e.g., the body portion 503 of the enclosure 502) defines the first audio passage 508 and the second audio passage 510. The enclosure 502 also includes a partition 515 separating (e.g., acoustically isolating) the first audio passage 508 from the second audio passage 510. In this way, sound transmitted by the first audio passage 508 does not combine with sound transmitted by the second audio passage 510 until the sound exits the strap arm 500 (e.g., via the first and second audio outlets 512 and 514) (except for those embodiments where the second audio outlet 514 feeds into the first audio passage 508). In some embodiments, the first audio passage 508 is an unimpeded space that terminates at the first audio outlet 512. The first audio passage 508 may have various cross-sectional shapes (e.g., various horn shapes that are flared in different directions), and the shape shown in FIG. 5C is merely one possible shape. In some embodiments, the length of the first audio passage 508 determines the minimum frequency of sound waves output by the first audio outlet 512.

The second audio passage 510 is a transmission line that terminates at the second audio outlet 514. As shown in FIG. 5C, the second audio passage 510 follows a meandering (e.g., winding or serpentine) path that switchbacks a number of times on its way to terminating at the second audio outlet 514. In some embodiments, the meandering path of the second audio passage 510 acts as a low-pass filter and filters out unwanted high frequencies of the sound generated by the rearward-facing surface of the driver 501. Furthermore, as a result of the increased length of the second audio passage 510 relative to the length of the first audio passage 508, acoustic waves that pass through the second audio passage 510 have a phase offset relative to acoustic waves that pass through the first audio passage 508. The phase offset corresponds to the length of the second audio passage 510. Therefore, adding (or removing) one or more switchbacks to (or from) the meandering path can modify the phase offset. Furthermore, acoustic waves output by the second audio outlet 514, due to the phase offset, constructively interfere with other acoustic waves output by the first audio outlet 512 at the tuned (center) frequency. To provide some context, in some embodiments the second audio passage 510 imparts a half wavelength (lambda, λ) delay on acoustic waves that travel through the meandering path of the second audio passage 510. The delay can be modified by increasing or decreasing the length of the second audio passage 510, as mentioned above.

It is noted that most conventional transmission line speakers include a transmission line having a cross-sectional area that is equal to or larger than a cross-sectional area of the speaker's diaphragm. This is the case because transmission lines are frequently implemented with large speakers where resonance needs to be eliminated (e.g., a large floor speaker), and, in such applications, listeners can be positioned several meters away from the forward-facing surface of the speaker. Because the listeners are positioned at a substantial distance from the speaker, sound of sufficient pressure needs to be output by the speaker so that it can be heard by the listeners (e.g., sound radiating into the far field drops off at a rate of 3-6 dB per doubling of distance based on the frequency dependent directivity of the sound source). Importantly, sound of equal pressure is also generated by the rearward-facing surface of the speaker, which travels through the transmission line. Thus, in order to maintain the sound's velocity below a threshold velocity while it travels through the transmission line (e.g., sound traveling above 10 meters per second may cause audible distortion), a cross-sectional area of the transmission line is increased to reduce the flow velocity of the sound traveling through the transmission line.

In contrast, the cross-sectional area of the second audio passage 510 is less than the cross-sectional area of the driver 501. For example, the driver 501 has a first cross-sectional area (A¹, dotted circle in FIG. 5C) and the second audio passage 510 has a second cross-sectional area (A², dotted rectangle in FIG. 5D) that is less than the first cross-sectional area (A¹). In some embodiments, the second cross-sectional area (A²) is less than half of the first cross-sectional area (A¹). For example, the second cross-sectional area (A²) may be one-eighth to one-fourth of the first cross-sectional area (A¹). In another example, the second cross-sectional area (A²) may be one-tenth (or less) of the first cross-sectional area (A¹). The cross-sectional area (A²) of the second audio passage 510 can be less than the cross-sectional area (A¹) of the driver 501 because: (i) the first and second audio outlets 512, 514 are designed to be located next to the user's ears, when the user is wearing the virtual-reality headset 200, and (ii) due to the close proximity of the user's ears and the audio outlets, a sound-pressure level of audio output by the driver 501 can be significantly reduced without compromising the user's ability to understand the audio. For example, the driver 501 can output audio at a low sound-pressure level, which can still be clearly understood by the listener (e.g., when the listener's ears are next to the audio outlets 512 and 514). Put another way, as the distance between listener and sound source decreases (e.g., separation distance approaches zero), the magnitude of the sound pressure output by the driver 501 can be decreased, and consequently, the transmission line can have a decreased cross-sectional area (e.g., the flow velocity of the sound traveling through the transmission line will not surpass the threshold velocity due to the reduced sound pressure). Also, the second audio passage 510 is able to shrink at a faster rate than the driver 501, as indicated by the differences in cross-sectional area between the second audio passage 510 and the driver 501.

FIG. 5D illustrates a cross-sectional view 550 of the transmission line speaker 500 (taken along line L1-L2 in FIG. 5C). The cross-sectional view 550 shows the cross-sectional area (A²) of the second audio passage 510. In the illustrated embodiment, the cross-sectional area (A²) of the second audio passage 510 is the same for each switchback. In other embodiments, the cross-sectional area (A²) of the second audio passage 510 may increase or decrease along a length of the second audio passage 510. For example, the second audio passage 510 may gradually narrow from start to finish, or vice versa.

FIG. 6 illustrates an embodiment of a sound outlet of a transmission line speaker 600 in accordance with some embodiments. FIG. 6 illustrates a simplified schematic of the transmission line speaker 600, which may be an example of the speakers 400 and 500, which is primarily provided for ease of discussion. It is noted that an outlet 608 of the transmission line 602 (e.g., the second audio passage 510) is not collocated with an outlet 606 of the audio passage 604, which is an example of the first audio passage 508. However, in practice, the outlet 608 and outlet 606 are typically defined adjacent to each other by the enclosure 502, as discussed above with reference to FIGS. 5A-5D.

FIG. 6 illustrates one possible audio radiation pattern 610 created, in part, by the outlet 608 (which is an example of the first audio outlet 512). As shown, the audio radiation pattern 610 is omni-directional, which results from the semi-rectangular shape of the outlet 608 (a similar result occurs when the outlet 608 is circular, elliptical, or rectangular). With the radiation pattern 610, the intensity of the audio is the same in all directions. In some circumstances, radiating audio omni-directionally is preferred. However, in other circumstances, it can be desirable to direct audio in a specific direction, such as toward a user's ears, when the target location is known and fixed, as is the case in virtual-reality headsets. Put another way, it is possible to increase audio intensity in a preferred direction and, potentially, increase audio intensity at a preferred/target location, as is discussed in further detail below with reference to FIGS. 7A-7F.

FIG. 7A illustrates another embodiment of a sound outlet of a transmission line speaker 700 in accordance with some embodiments. Like FIG. 6, FIGS. 7A-7F are simplified schematics of the transmission line speaker 700, which is an example of the speakers 400 and 500. As shown, the transmission line speaker 700 includes an audio passage 702, which is an example of the first audio passage 508 (FIGS. 5A-5D). As also shown, the audio passage 702 defines multiple openings 704-A through 704-D, which are examples of the first audio outlet 512-B discussed above with reference to FIGS. 5B and 5C (e.g., openings 518-A through 518-G). The multiple openings 704-A through 704-D are defined along a length of the audio passage 702, and in the illustrated embodiment, are equally spaced apart. The multiple openings 704-A through 704-D are used to impart a propagation delay on acoustic waves generated by the speaker 700 (the benefits of the propagation delay are detailed below). While four openings 704 are shown in FIGS. 7A-7F, different numbers of openings 704 can be used. Additionally, the spacing distance between adjacent openings 704 varies in some embodiments, which modifies the direction and intensity of the resulting audio. For example, if the multiple openings 704 are equally spaced apart (e.g., as shown in FIG. 7A), then audio exiting the multiple openings 704 may travel toward a first target location, and, if the spacing distances increase along a length of the audio passage 702, then audio exiting the multiple openings 704 may travel toward a second target location that differs from the first target location.

FIGS. 7B-7F illustrate sound propagating from the transmission line speaker 700 in a delayed manner. In FIG. 7B, the driver 701 is generating a plurality of sound waves, whereby one or more first sound waves 706 of the plurality of sound waves exit a first opening 704-A of the multiple openings 704. Now with reference to FIG. 7C, the one or more first sound waves 706 propagate away from the first opening 704-A. In addition, one or more second sound waves 708 of the plurality of sound waves exit a second opening 704-B of the multiple openings 704. As shown in FIG. 7D, the one or more first sound waves 706 continue to propagate away from the first opening 704-A, while the one or more second sound waves 708 begin their propagation away from the second opening 704-B. Importantly, the one or more first sound waves 706 and the one or more second sound waves 708 together form a unified waveform 709 in a predefined direction (e.g., rightward). Moreover, the intensity of the audio output by the speaker 700 is the greatest in FIG. 7D at the unified waveform 709. In addition, one or more third sound waves 710 of the plurality of sound waves are shown exiting a third opening 704-C of the multiple openings 704. It is noted that the circumstances shown in FIG. 7B occur at a first time, the circumstances shown in FIG. 7C occur at a second time after the first time, and the circumstances shown in FIG. 7D occur at a third time after the second time.

Now with reference to FIG. 7E (which occurs at a fourth time after the third time), the one or more first sound waves 706 and the one or more second sound waves 708 continue to propagate from the first opening 704-A and the second opening 704-B, respectively. In addition, the one or more third sound waves 710 begin to propagate away from the third opening 704-C. At this stage, the one or more first sound waves 706, the one or more second sound waves 708, and the one or more third sound waves 710 together form a new unified waveform 711 in the predefined direction (e.g., rightward). Moreover, the intensity of the audio output by the speaker 700 is the greatest in FIG. 7E at the unified waveform 711. In addition, one or more fourth sound waves 712 of the plurality of sound waves are shown exiting a fourth opening 704-D of the multiple openings 704. It is noted that the intensity of the unified waveform 711 is greater than the intensity of the unified waveform 709, due to the unified waveform 711 being composed of three different sound waves, whereas the unified waveform 709 is composed of two different sound waves.

As noted above, the spacing distance between openings 704 can be modified. For example, the openings 704 may be spaced apart equally or unequally. In some embodiments, changing the spacing distance between openings 704 can modify the location of the unified waveform (e.g., shift the unified waveform upward, downward, rightward, or leftward (or some combination thereof) from the locations shown in FIGS. 7C and 7D). Additionally, changing the geometry of openings 704 in general affects the directivity of the sound on a frequency dependent basis, including changing the angle of attack of the exit, and the acoustic impedance of the exit.

In FIG. 7F (which occurs at a fifth time after the fourth time), the one or more first sound waves 706, the one or more second sound waves 708, and the one or more third sound waves 710 continue to propagate from the first opening 704-A, the second opening 704-B, and the third opening 704-C, respectively. In addition, the one or more fourth sound waves 712 begin to propagate away from the fourth opening 704-D. Thus, the one or more first sound waves 706, the one or more second sound waves 708, the one or more third sound waves 710, and the one or more fourth sound waves 712 together form a new unified waveform 713 in the predefined direction. The intensity of the audio output by the speaker 700 is the greatest in FIG. 7F at the unified waveform 713. Moreover, a target location 714 of the audio output by the speaker 700 is shown adjacent to the unified waveform 713. Accordingly, the openings 704 are arranged so that maximum intensity of the audio output by the speaker 700 is achieved next to the target location 714. Such a design creates an efficient speaker that also reduces audio leakage into the surrounding environment.

It is noted that the intensity of the unified waveform 713 is greater than the intensity of the unified waveform 709 and the unified waveform 711. This is the case because the unified waveform 713 is composed of four different sound waves, whereas the unified waveform 709 is composed of two different sound waves and the unified waveform 711 is composed of three different sound waves.

Embodiments of this disclosure may include or be implemented in conjunction with various types of artificial-reality systems. Artificial reality may constitute a form of reality that has been altered by virtual objects for presentation to a user. Such artificial reality may include and/or represent virtual reality (VR), augmented reality (AR), mixed reality (MR), hybrid reality, or some combination and/or variation of one or more of the these. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to a viewer). Additionally, in some embodiments, artificial reality may also be associated with applications, products, accessories, services, or some combination thereof, which are used, for example, to create content in an artificial reality and/or are otherwise used in (e.g., to perform activities in) an artificial reality.

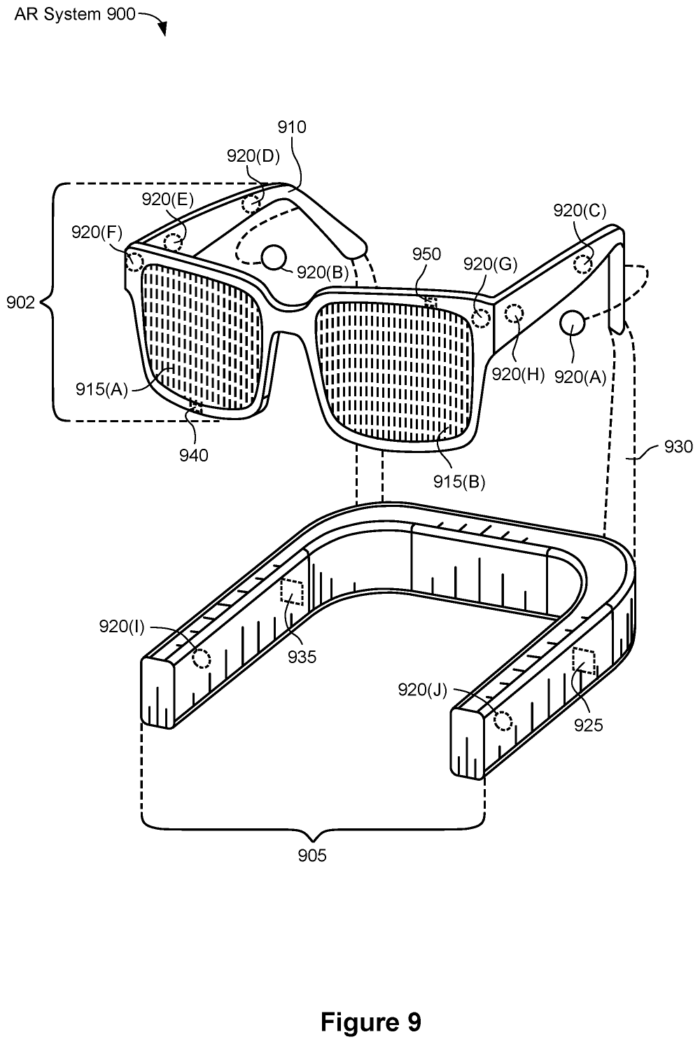

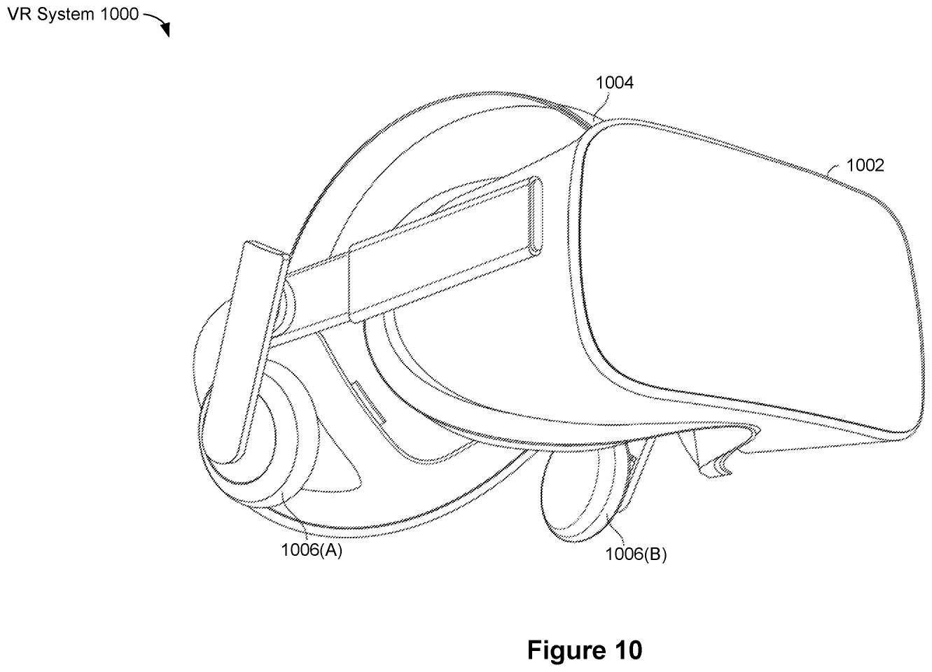

Artificial-reality systems may be implemented in a variety of different form factors and configurations. Some artificial-reality systems are designed to work without near-eye displays (NEDs), an example of which is the artificial-reality system 800 in FIG. 8. Other artificial-reality systems include an NED, which provides visibility into the real world (e.g., the augmented-reality (AR) system 900 in FIG. 9) or that visually immerses a user in an artificial reality (e.g., the virtual-reality (VR) system 1000 in FIG. 10). While some artificial-reality devices are self-contained systems, other artificial-reality devices communicate and/or coordinate with external devices to provide an artificial-reality experience to a user. Examples of such external devices include handheld controllers, mobile devices, desktop computers, devices worn by a user, devices worn by one or more other users, and/or any other suitable external system.

FIGS. 8-10 provide additional examples of the devices used in a system 100. The artificial-reality system 800 in FIG. 8 generally represents a wearable device dimensioned to fit about a body part (e.g., a head) of a user. The artificial-reality system 800 may include the functionality of a wearable device, and may include functions not described above. As shown, the artificial-reality system 800 includes a frame 802 (e.g., a band or wearable structure) and a camera assembly 804, which is coupled to the frame 802 and configured to gather information about a local environment by observing the local environment (and may include a display 804 that displays a user interface). In some embodiments, the artificial-reality system 800 includes output transducers 808(A) and 808(B) and input transducers 810. The output transducers 808(A) and 808(B) may provide audio feedback, haptic feedback, and/or content to a user, and the input audio transducers may capture audio (or other signals/waves) in a user's environment.

Thus, the artificial-reality system 800 does not include a near-eye display (NED) positioned in front of a user's eyes. Artificial-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While the artificial-reality system 800 may not include an NED, the artificial-reality system 800 may include other types of screens or visual feedback devices (e.g., a display screen integrated into a side of the frame 802).

The embodiments discussed in this disclosure may also be implemented in artificial-reality systems that include one or more NEDs. For example, as shown in FIG. 9, the AR system 900 may include an eyewear device 902 with a frame 910 configured to hold a left display device 915(B) and a right display device 915(A) in front of a user's eyes. The display devices 915(A) and 915(B) may act together or independently to present an image or series of images to a user. While the AR system 900 includes two displays, embodiments of this disclosure may be implemented in AR systems with a single NED or more than two NEDs.

In some embodiments, the AR system 900 includes one or more sensors, such as the sensors 940 and 950. The sensors 940 and 950 may generate measurement signals in response to motion of the AR system 900 and may be located on substantially any portion of the frame 910. Each sensor may be a position sensor, an inertial measurement unit (IMU), a depth camera assembly, or any combination thereof. The AR system 900 may or may not include sensors or may include more than one sensor. In embodiments in which the sensors include an IMU, the IMU may generate calibration data based on measurement signals from the sensors. Examples of the sensors include, without limitation, accelerometers, gyroscopes, magnetometers, other suitable types of sensors that detect motion, sensors used for error correction of the IMU, or some combination thereof. Sensors are also discussed above with reference to FIG. 1.

The AR system 900 may also include a microphone array with a plurality of acoustic sensors 920(A)-920(J), referred to collectively as the acoustic sensors 920. The acoustic sensors 920 may be transducers that detect air pressure variations induced by sound waves. Each acoustic sensor 920 may be configured to detect sound and convert the detected sound into an electronic format (e.g., an analog or digital format). The microphone array in FIG. 9 may include, for example, ten acoustic sensors: 920(A) and 920(B), which may be designed to be placed inside a corresponding ear of the user, acoustic sensors 920(C), 920(D), 920(E), 920(F), 920(G), and 920(H), which may be positioned at various locations on the frame 910, and/or acoustic sensors 920(I) and 920(J), which may be positioned on a corresponding neckband 905. In some embodiments, the neckband 905 is an example of a computer system.

The configuration of the acoustic sensors 920 of the microphone array may vary. While the AR system 900 is shown in FIG. 9 having ten acoustic sensors 920, the number of acoustic sensors 920 may be greater or less than ten. In some embodiments, using more acoustic sensors 920 may increase the amount of audio information collected and/or the sensitivity and accuracy of the audio information. In contrast, using a lower number of acoustic sensors 920 may decrease the computing power required by a controller 925 to process the collected audio information. In addition, the position of each acoustic sensor 920 of the microphone array may vary. For example, the position of an acoustic sensor 920 may include a defined position on the user, a defined coordinate on the frame 910, an orientation associated with each acoustic sensor, or some combination thereof.

The acoustic sensors 920(A) and 920(B) may be positioned on different parts of the user's ear, such as behind the pinna or within the auricle or fossa. In some embodiments, there are additional acoustic sensors on or surrounding the ear in addition to acoustic sensors 920 inside the ear canal. Having an acoustic sensor positioned next to an ear canal of a user may enable the microphone array to collect information on how sounds arrive at the ear canal. By positioning at least two of the acoustic sensors 920 on either side of a user's head (e.g., as binaural microphones), the AR device 900 may simulate binaural hearing and capture a 3D stereo sound field around about a user's head. In some embodiments, the acoustic sensors 920(A) and 920(B) may be connected to the AR system 900 via a wired connection, and in other embodiments, the acoustic sensors 920(A) and 920(B) may be connected to the AR system 900 via a wireless connection (e.g., a Bluetooth connection). In still other embodiments, the acoustic sensors 920(A) and 920(B) may not be used at all in conjunction with the AR system 900.

The acoustic sensors 920 on the frame 910 may be positioned along the length of the temples, across the bridge, above or below the display devices 915(A) and 915(B), or some combination thereof. The acoustic sensors 920 may be oriented such that the microphone array is able to detect sounds in a wide range of directions surrounding the user wearing AR system 900. In some embodiments, an optimization process may be performed during manufacturing of the AR system 900 to determine relative positioning of each acoustic sensor 920 in the microphone array.

The AR system 900 may further include or be connected to an external device (e.g., a paired device), such as a neckband 905. As shown, the neckband 905 may be coupled to the eyewear device 902 via one or more connectors 930. The connectors 930 may be wired or wireless connectors and may include electrical and/or non-electrical (e.g., structural) components. In some cases, the eyewear device 902 and the neckband 905 operate independently without any wired or wireless connection between them. While FIG. 9 illustrates the components of the eyewear device 902 and the neckband 905 in example locations on the eyewear device 902 and the neckband 905, the components may be located elsewhere and/or distributed differently on the eyewear device 902 and/or on the neckband 905. In some embodiments, the components of the eyewear device 902 and the neckband 905 may be located on one or more additional peripheral devices paired with the eyewear device 902, the neckband 905, or some combination thereof. Furthermore, the neckband 905 generally represents any type or form of paired device. Thus, the following discussion of neckband 905 may also apply to various other paired devices, such as smart watches, smart phones, wrist bands, other wearable devices, hand-held controllers, tablet computers, or laptop computers.

Pairing external devices, such as a neckband 905, with AR eyewear devices may enable the eyewear devices to achieve the form factor of a pair of glasses while still providing sufficient battery and computation power for expanded capabilities. Some or all of the battery power, computational resources, and/or additional features of the AR system 900 may be provided by a paired device or shared between a paired device and an eyewear device, thus reducing the weight, heat profile, and form factor of the eyewear device overall while still retaining desired functionality. For example, the neckband 905 may allow components that would otherwise be included on an eyewear device to be included in the neckband 905 because users may tolerate a heavier weight load on their shoulders than they would tolerate on their heads. The neckband 905 may also have a larger surface area over which to diffuse and disperse heat to the ambient environment. Thus, the neckband 905 may allow for greater battery and computation capacity than might otherwise have been possible on a stand-alone eyewear device. Because weight carried in the neckband 905 may be less invasive to a user than weight carried in the eyewear device 902, a user may tolerate wearing a lighter eyewear device and carrying or wearing the paired device for greater lengths of time than the user would tolerate wearing a heavy standalone eyewear device, thereby enabling an artificial-reality environment to be incorporated more fully into a user's day-to-day activities.

The neckband 905 may be communicatively coupled with the eyewear device 902 and/or to other devices (e.g., a wearable device). The other devices may provide certain functions (e.g., tracking, localizing, depth mapping, processing, storage, etc.) to the AR system 900. In the embodiment of FIG. 9, the neckband 905 includes two acoustic sensors 920(I) and 920(J), which are part of the microphone array (or potentially form their own microphone subarray). The neckband 905 includes a controller 925 and a power source 935.

The acoustic sensors 920(I) and 920(J) of the neckband 905 may be configured to detect sound and convert the detected sound into an electronic format (analog or digital). In the embodiment of FIG. 9, the acoustic sensors 920(I) and 920(J) are positioned on the neckband 905, thereby increasing the distance between neckband acoustic sensors 920(I) and 920(J) and the other acoustic sensors 920 positioned on the eyewear device 902. In some cases, increasing the distance between the acoustic sensors 920 of the microphone array improves the accuracy of beamforming performed via the microphone array. For example, if a sound is detected by the acoustic sensors 920(C) and 920(D) and the distance between acoustic sensors 920(C) and 920(D) is greater than, for example, the distance between the acoustic sensors 920(D) and 920(E), the determined source location of the detected sound may be more accurate than if the sound had been detected by the acoustic sensors 920(D) and 920(E).

The controller 925 of the neckband 905 may process information generated by the sensors on the neckband 905 and/or the AR system 900. For example, the controller 925 may process information from the microphone array, which describes sounds detected by the microphone array. For each detected sound, the controller 925 may perform a direction of arrival (DOA) estimation to estimate a direction from which the detected sound arrived at the microphone array. As the microphone array detects sounds, the controller 925 may populate an audio data set with the information. In embodiments in which the AR system 900 includes an IMU, the controller 925 may compute all inertial and spatial calculations from the IMU located on the eyewear device 902. The connector 930 may convey information between the AR system 900 and the neckband 905 and between the AR system 900 and the controller 925. The information may be in the form of optical data, electrical data, wireless data, or any other transmittable data form. Moving the processing of information generated by the AR system 900 to the neckband 905 may reduce weight and heat in the eyewear device 902, making it more comfortable to a user.

The power source 935 in the neckband 905 may provide power to the eyewear device 902 and/or to the neckband 905. The power source 935 may include, without limitation, lithium-ion batteries, lithium-polymer batteries, primary lithium batteries, alkaline batteries, or any other form of power storage. In some cases, the power source 935 may be a wired power source. Including the power source 935 on the neckband 905 instead of on the eyewear device 902 may help better distribute the weight and heat generated by the power source 935.

As noted, some artificial-reality systems may, instead of blending an artificial-reality with actual reality, substantially replace one or more of a user's sensory perceptions of the real world with a virtual experience. One example of this type of system is a head-worn display system, such as the VR system 1000 in FIG. 10, which mostly or completely covers a user's field of view. The VR system 1000 is similar to the VR system 1000 of FIGS. 2A-2B, in that it may include a front rigid body 1002 and a band 1004 shaped to fit around a user's head. In some embodiments, the VR system 1000 includes output audio transducers 1006(A) and 1006(B), as shown in FIG. 10. Alternatively, in some embodiments, the VR system 1000 includes output audio transducers as discussed above with reference to FIGS. 2A-7E. Furthermore, while not shown in FIG. 10, the front rigid body 1002 may include one or more electronic elements, including one or more electronic displays, one or more IMUs, one or more tracking emitters or detectors, and/or any other suitable device or system for creating an artificial-reality experience.

Artificial-reality systems may include a variety of types of visual feedback mechanisms. For example, display devices in the AR system 900 and/or the VR system 1000 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems also include optical subsystems having one or more lenses (e.g., conventional concave or convex lenses, Fresnel lenses, or adjustable liquid lenses) through which a user may view a display screen. These systems and mechanisms are discussed in further detail above with reference to FIG. 1.

In addition to or instead of using display screens, some artificial-reality systems include one or more projection systems. For example, display devices in the AR system 900 and/or the VR system 1000 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system.

Artificial-reality systems may also include various types of computer vision components and subsystems. For example, the AR system 800, the AR system 900, and/or the VR system 1000 may include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIGS. 8 and 10, the output audio transducers 808(A), 808(B), 1006(A), and 1006(B) may include voice coil speakers, ribbon speakers, electrostatic speakers, piezoelectric speakers, bone conduction transducers, cartilage conduction transducers, and/or any other suitable type or form of audio transducer. Similarly, the input audio transducers 810 may include condenser microphones, dynamic microphones, ribbon microphones, and/or any other type or form of input transducer. In some embodiments, a single transducer may be used for both audio input and audio output. In some embodiments, an output audio transducer is coupled with a transmission line speaker, such as the transmission line speaker 500.

Some AR systems map a user's environment using techniques referred to as “simultaneous location and mapping” (SLAM). SLAM mapping and location identifying techniques may involve a variety of hardware and software tools that can create or update a map of an environment while simultaneously keeping track of a device's or a user's location and/or orientation within the mapped environment. SLAM may use many different types of sensors to create a map and determine a device's or a user's position within the map.

SLAM techniques may, for example, implement optical sensors to determine a device's or a user's location, position, or orientation. Radios, including Wi-Fi, Bluetooth, global positioning system (GPS), cellular or other communication devices may also be used to determine a user's location relative to a radio transceiver or group of transceivers (e.g., a Wi-Fi router or group of GPS satellites). Acoustic sensors such as microphone arrays or 2D or 3D sonar sensors may also be used to determine a user's location within an environment. AR and VR devices (such as the systems 800, 900, and 1000) may incorporate any or all of these types of sensors to perform SLAM operations such as creating and continually updating maps of a device's or a user's current environment. In at least some of the embodiments described herein, SLAM data generated by these sensors may be referred to as “environmental data” and may indicate a device's or a user's current environment. This data may be stored in a local or remote data store (e.g., a cloud data store) and may be provided to a user's artificial-reality device on demand.

When a user is wearing an AR headset or VR headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to herein as “localization,” and the process of rendering playback of the audio source signal to appear as if it is coming from a specific direction may be referred to herein as “spatialization.”

Localizing an audio source may be performed in a variety of different ways. In some cases, an AR or VR headset may initiate a Direction of Arrival (“DOA”) analysis to determine the location of a sound source. The DOA analysis may include analyzing the intensity, spectra, and/or arrival time of each sound at the AR/VR device to determine the direction from which the sound originated. In some cases, the DOA analysis may include any suitable algorithm for analyzing the surrounding acoustic environment in which the artificial-reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy, including ear canal length and the positioning of the ear drum. The artificial-reality device may provide an alignment and orientation guide, which the user may follow to customize the sound signal presented to the user based on a personal HRTF. In some embodiments, an AR or VR device may implement one or more microphones to listen to sounds within the user's environment. The AR or VR device may use a variety of different array transfer functions (ATFs) (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using an ATF may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, infrared radiation (IR) sensors, heat sensors, motion sensors, global positioning system (GPS) receivers, or in some cases, sensor that detect a user's eye movements. For example, an artificial-reality device may include an eye tracker or gaze detector that determines where a user is looking. Often, a user's eyes will look at the source of a sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an acoustic transfer function may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (e.g., using any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to a user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A sound-producing device, comprising:
a housing having:
(i) a head portion, which defines a chamber; and
(ii) a body portion, distinct from the head portion, which defines (1) a first audio passage to transmit a first sound wave from the chamber to a first audio outlet that outputs sound and (2) a second audio passage, distinct from the first audio passage, to transmit a second sound wave, distinct from the first sound wave, from the chamber to a second audio outlet that outputs sound; and
a driver, positioned in the chamber, for producing the first sound wave and the second sound wave simultaneously, wherein:
(a) the driver includes a forward-facing surface configured to produce the first sound wave in a first direction into the first audio passage;
(b) the driver includes a rearward-facing surface configured to produce the second sound wave in a second direction, distinct from the first direction, into the second audio passage, wherein the second sound wave is produced simultaneously with the first sound wave; and
(c) a length of the second audio passage is greater than a length of the first audio passage, such that the second sound wave constructively interferes with the first sound wave.

2. The sound-producing device of claim 1, wherein:
the driver has a first cross-sectional area, and
the second audio passage has a second cross-sectional area that is less than the first cross-sectional area.

3. The sound-producing device of claim 2, wherein the second cross-sectional area is less than half of the first cross-sectional area.

4. The sound-producing device of claim 2, wherein the second cross-sectional area is approximately one-tenth of the first cross-sectional area.

5. The sound-producing device of claim 1, wherein:
the head portion is sized to receive the driver.

6. The sound-producing device of claim 1, wherein:
the first and second audio passages are adjacent to each other in the body portion, and
the first and second audio passages both extend away from the head portion along a length of the body portion.

7. The sound-producing device of claim 1, wherein:
the head portion further comprises a lid; and
the lid seals the chamber to create a back volume between the rearward-facing surface of the driver and an interior of the head portion.

8. The sound-producing device of claim 7, wherein the lid is detachably coupled to the head portion.

9. The sound-producing device of claim 7, wherein:
the head portion comprises a surface and sidewalls extending from the surface; and
the surface and sidewalls collectively define the chamber.

10. The sound-producing device of claim 9, wherein:
the surface defines one or more first audio inlets joining the chamber and the first audio passage; and
the sidewalls define one or more second audio inlets joining the chamber and the second audio passage.

11. The sound-producing device of claim 1, wherein the second audio passage follows a serpentine path.

12. The sound-producing device of claim 1, wherein:
acoustic waves that pass through the second audio passage have a phase offset relative to acoustic waves that pass through the first audio passage; and
the phase offset corresponds to the length of the second audio passage.

13. The sound-producing device of claim 12, wherein acoustic waves output by the second audio outlet, due to the phase offset, constructively interfere with other acoustic waves output by the first audio outlet at a target location.

14. The sound-producing device of claim 1, wherein sound output by the first audio passage is directed in a predetermined direction according to a cross-sectional shape of the first audio passage and an arrangement of the first audio outlet.

15. The sound-producing device of claim 14, wherein the first audio outlet is composed of multiple openings defined along a length of the first audio passage.

16. The sound-producing device of claim 1, wherein the length of the first audio passage determines a minimum frequency of sound waves output by the first audio outlet.

17. The sound-producing device of claim 1, wherein:
the housing has opposing first and second end portions;
the driver is positioned toward the first end portion of the housing; and
the first and second audio outlets are defined toward the second end portion of the housing.

18. The sound-producing device of claim 1, wherein a non-zero distance separates the forward-facing surface of the driver from the first audio outlet.

19. The sound-producing device of claim 1, wherein the first and second audio passages are made from tubing.

20. A head-mounted display, comprising:
a body; and
one or more strap arms securing the body to a user's head, each strap arm including:
a housing having:
(i) a head portion, which defines a chamber; and
(ii) a body portion, distinct from the head portion, which defines (1) a first audio passage to transmit a first sound wave from the chamber to a first audio outlet that outputs sound and (2) a second audio passage, distinct from the first audio passage, to transmit a second sound wave, distinct form the first sound wave, from the chamber to a second audio outlet that outputs sound; and
a driver, positioned in the chamber, for producing the first sound wave and the second sound wave simultaneously, wherein:
(a) the driver includes a forward-facing surface configured to produce the first sound wave in a first direction into the first audio passage;
(b) the driver includes a rearward-facing surface configured to produce the second sound wave in a second direction, distinct from the first direction, into the second audio passage, wherein the second sound wave is produced simultaneously with the first sound wave; and
(c) a length of the second audio passage is greater than a length of the first audio passage, such that the second sound wave constructively interferes with the first sound wave.
